(19) United States
(12) Patent Application Publication
(10) Pub. No.: US 2006/0279638 A1
(43) Pub. Date: Dec. 14, 2006

(54) Photographing apparatus

(75) Inventors: Shinya Matsuda, Takarazuka-shi (JP); Naoki Kubo, Takarazuka-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.,

(21) Appl. No.: 11/445,970

(22) Filed: Jun. 2, 2006

(30) Foreign Application Priority Data
Jun. 10, 2005 (JP) 2005-171740

(51) Int. Cl. H04N 5/228

(52) U.S. Cl. 348/208.7

(57) ABSTRACT

A first frame has a U-shaped cross section and includes first and second bent portions, and an X-axis actuator is mounted at a specified position of the outer surface of the first bent portion. A second frame has a U-shaped cross section and includes first and second bent portions, and a Y-axis actuator is mounted at a specified position of the outer surface of the first bent portion. A Z-axis actuator is mounted at a suitable position of one end surface of an image pickup unit with respect to X-axis direction. The second frame is disposed between the first and second bent portions of the first frame, and the image pickup unit is disposed between the first and second bent portions of the second frame. The image pickup unit is made movable along three axial directions by the respective actuators. There can be provided a dust removing device and a photographing apparatus with which a clear image having no or little influence of dust can be obtained even if the dust is attached to an image pickup unit and the like.

### PHOTOGRAPHING APPARATUS

This application is based on patent application No. 2005-171740 filed in Japan, the contents of which are hereby incorporated by references.

### BACKGROUND OF THE INVENTION

1. Field of the Invention

The present invention relates to a photographing apparatuses, particularly, to a countermeasure technology in the case where dust is attached to dust attachment objects likely to influence the image quality of a photographed image by the attachment of dust such as filters and glasses disposed on a light path between an image pickup device and a photographic optical system.

2. Description of the Related Art

Various technologies for suppressing reduction in the image quality of a photographed image resulting from the presence of dust attached to a filter such as a low-pass filter upon mounting and detaching an interchangeable lens have been conventionally proposed, for example, for a single-lens reflex camera.

For example, Japanese Utility Model Registration No. 2541566 discloses a technology according to which, in order to remove waterdrops attached to a hood glass mounted on the front surface of a monitor camera, a piezoelectric vibrator is mounted on the underside of a hood glass by means of adhesive, a resonance system including the hood glass and the vibrator is caused to vibrate at a resonance frequency to produce a standing wave at a specified position of the piezoelectric vibrator, and the hood glass is vibrated along a direction normal to the glass surface thereof by this standing wave.

Further, Japanese Unexamined Patent Publication No. H08-79633 discloses a technology according to which a CCD line sensor is fixedly attached to the upper surface of a bearer, a piezoelectric element is disposed while being held in contact with a specified portion of the bearer, and a voltage whose frequency and amplitude are changed with time is applied to the piezoelectric element, whereby a deformation of the piezoelectric element is imparted to the CCD line sensor as vibration along a direction parallel to a light receiving surface of the CCD line sensor.

However, since only the vibration is imparted along one direction to an object to be vibrated in both of the above publications, an attached matter can be caused to drop off if the vibrating direction coincides with a direction parallel to an attaching surface of the attached matter (shear direction). However, if these two directions do not coincide with each other, it is difficult to drop the attached matter off.

### SUMMARY OF THE INVENTION

It is an object of the present invention to provide a photographing apparatus which is free from the problem residing in the prior art.

It is another object of the present invention to provide a photographing apparatus which can produce a clear image having no or little influence of dust even if dust is attached to an image pickup unit or the like.

According to an aspect of the invention, a photographing apparatus is provided with an image pickup unit for receiving an image of light coming through a photographic optical system having an optical axis, and a driving mechanism for moving the image pickup unit in a plurality of different directions over a plane intersecting the optical axis. Further, the apparatus is provided with a shake corrector for controlling the driving mechanism to correct a shake of the light image due to an externally given shake, and a vibration imparter for controlling the driving mechanism to impart vibrations to the image pickup unit to thereby remove dust from the image pickup unit.

These and other objects, features, aspects and advantages of the present invention will become more apparent upon a reading of the following detailed description and accompanying drawings.

### BRIEF DESCRIPTION OF THE DRAWINGS

FIG. 1 is a front view showing a construction of a photographing apparatus according to an embodiment of the invention;

FIG. 2 is a rear view showing the construction of the photographing apparatus;

FIG. 3 is a diagram showing an internal construction of the photographing apparatus;

FIG. 4 is an exploded perspective view showing a construction of an image pickup unit;

FIG. 5 is a perspective view showing a construction of an image pickup unit driving mechanism;

FIGS. 6A and 6B are an exploded perspective view and an assembled perspective view showing a construction of an X-axis actuator, a Y-axis actuator and a Z-axis actuator;

FIG. 7 is a graph chart showing a waveform of a drive pulse to be applied to the X-axis actuator, the Y-axis actuator and the Z-axis actuator;

FIG. 8 is a graph chart showing a change in the expanding/contracting speed of a piezoelectric element with time and a change in the displacement of a frictional coupling portion with time;

FIGS. 9A to 9D are diagrams showing a concept of a removal capability in the case where dusts are attached to a minute concave surface on the front face of a cover glass;

FIG. 10 is a block diagram showing an electrical construction of the entire photographing apparatus with an interchangeable lens mounted on an apparatus main body;

FIG. 11 is a perspective view showing a construction of an auxiliary light irradiating portion;

FIG. 12 is a flowchart showing a dust removal processing carried out by a central controller;

FIGS. 13A and 13B are diagrams showing a modified image pickup unit driving mechanism;

FIG. 14 is a perspective view showing another modified image pickup unit driving mechanism;

FIGS. 15A and 15B are perspective views showing still another modified image pickup unit driving mechanism;

FIG. 16 is a perspective view showing yet still another modified image pickup unit driving mechanism;

FIGS. 17A to 17C are diagrams showing further another modified image pickup unit driving mechanism;

FIG. 18A is a diagram showing a first frame of the image pickup unit driving mechanism when viewed in Z-axis direction;

FIG. 18B is a diagram showing a second frame of the image pickup unit driving mechanism when viewed in Z-axis direction;

FIG. 18C is a diagram showing a third frame of the image pickup unit driving mechanism when viewed in X-axis direction;

FIGS. 19A and 19B are views showing still further another modified image pickup unit driving mechanism; and

FIG. 20 is a diagram showing yet still further another modified image pickup unit driving mechanism.

### DETAILED DESCRIPTION OF THE PREFERRED EMBODIMENTS OF THE INVENTION

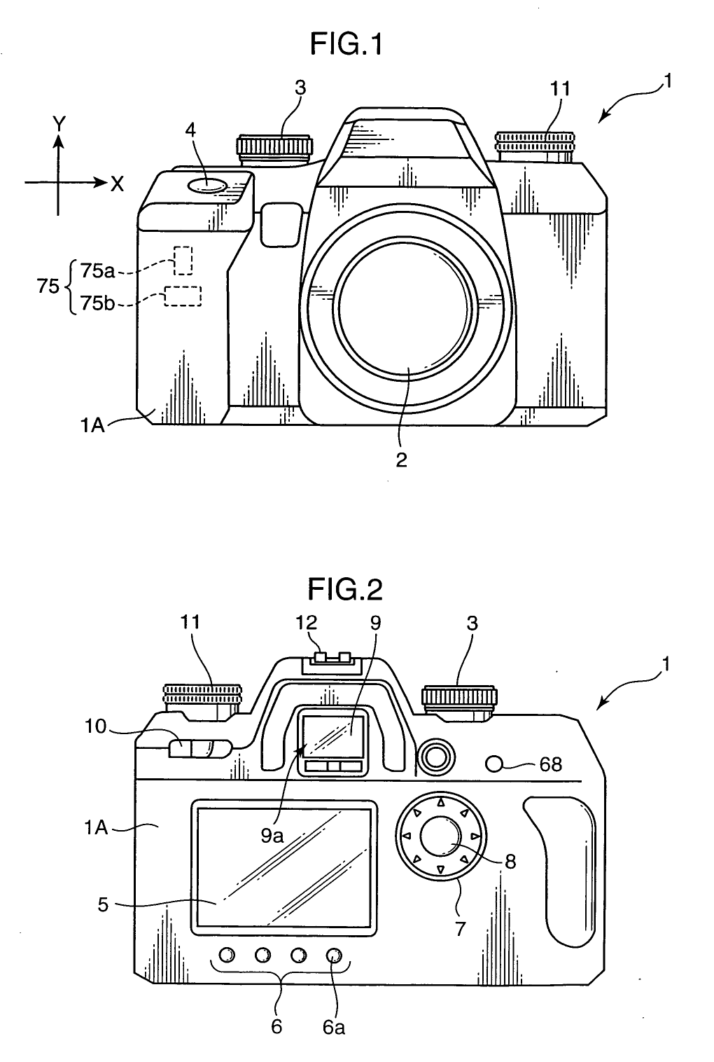

Hereinafter, a photographing apparatus according to an embodiment of the present invention is described with reference to FIGS. 1 to 3. It should be noted that same members and the like are identified by the same reference numerals in FIGS. 1 to 3.

A photographing apparatus 1 of this embodiment is provided with an interchangeable lens 2 mountable substantially in the center of the front surface of an apparatus main body 1A, a first mode setting dial 3 disposed at a specified position of the upper surface, a shutter button 4 disposed at an upper corner, an LCD (liquid crystal display) disposed on the rear surface, set buttons 6 disposed below the LCD 5, a direction key 7 disposed at a side of the LCD 5, a push button 8 disposed inside the direction key 7, an optical viewfinder 9 disposed above the LCD 5, a main switch 10 disposed at a side of the optical viewfinder 9, a second mode setting dial 11 disposed near the main switch 10, and a connection terminal 12 disposed above the optical viewfinder 9.

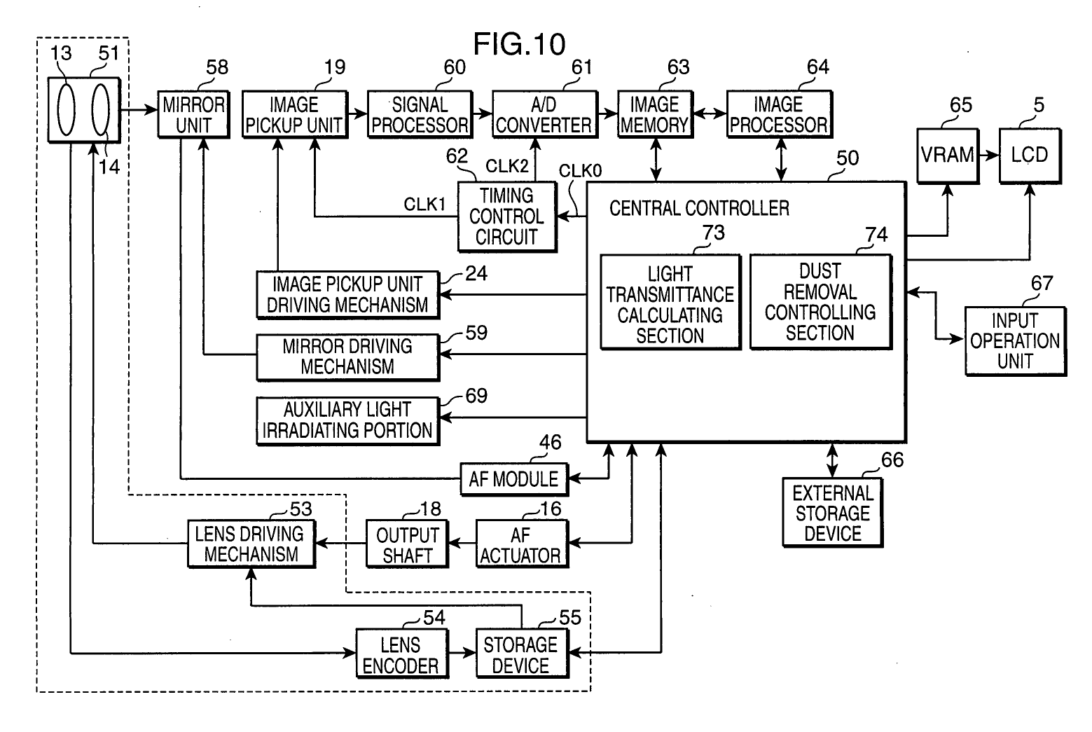

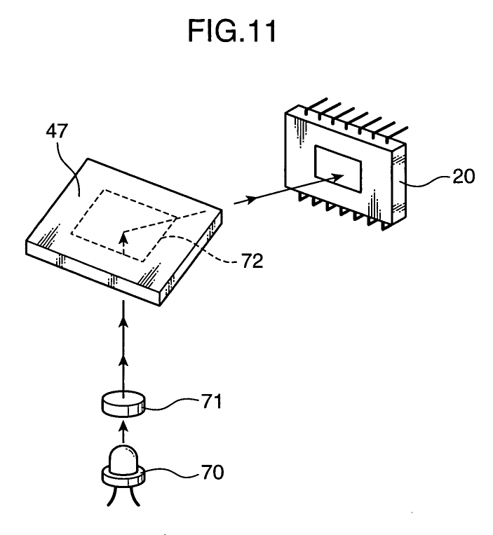

The interchangeable lens 2 is constructed such that a plurality of lenses as optical elements are arranged in a direction perpendicular to the plane of FIG. 1 in a barrel. The optical elements built in the interchangeable lens 2 include a zooming lens 13 for zooming (see FIG. 10) and a focusing lens 14 for focusing (see FIG. 10), and zooming and focusing are carried out by driving these lens 13, 14 along an optical axis direction.

The interchangeable lens 2 includes an unillustrated operation ring rotatable along the outer circumferential surface of the barrel and provided at a specified position on the outer circumferential surface of the barrel. The zoom lens 13 is a manual zoom lens that is moved along the optical axis direction according to a rotated direction and a rotated amount of the operation ring and set at a zooming magnification (photographing magnification) corresponding to the position reached by the above movement. It should be noted that the interchangeable lens 2 can be detached from the apparatus main body 1A by pushing an unillustrated detach button.

The first mode setting dial 3 is a substantially disk-like member rotatable in a plane substantially parallel to the upper surface of the photographing apparatus 1 and adapted to alternatively select modes and functions available in the photographing apparatus 1 such as a photographing mode for photographing a still image or moving images and a reproduction mode for reproducing already recorded images. Although not shown, characters representing the respective functions are inscribed at specified intervals along the outer peripheral edge of the upper surface of the first mode setting dial 3, and a function corresponding to the character set at a position facing an indication pointer provided at a specified position of the apparatus main body 1A is carried out.

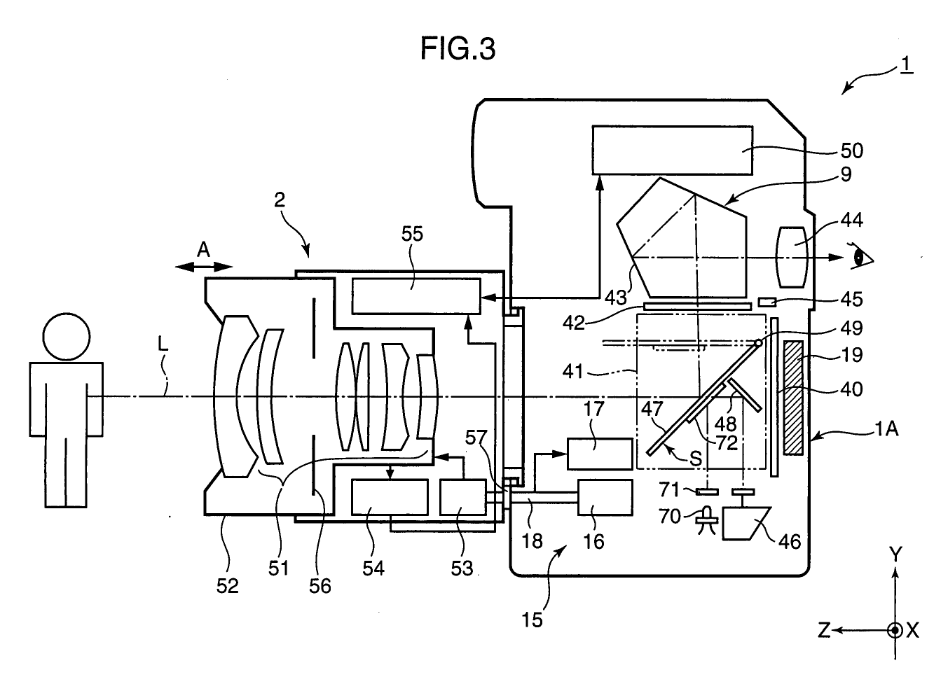

The shutter button 4 is a button pressable in two stages, i.e. a partly pressed state reached by being pressed halfway and a fully pressed state reached by being fully pressed, and is mainly adapted to instruct a timing of an exposure operation by an image pickup unit 19 (see FIGS. 3 and 10) to be described later a photographing standby state is set where exposure control values (shutter speed and aperture value) and the like are set by pressing the shutter button 4 halfway, whereas an exposing operation by the image pickup unit 19 for generating an image of an object to be recorded in an external storage 66 (see FIG. 10) to be described later is started by fully pressing the shutter button 4.

The partly pressed state of the shutter button 4 is detected by an unillustrated switch S1 being turned on, whereas the fully pressed state thereof is detected by an unillustrated switch S2 being turned on.

The LCD 5 includes a color liquid crystal panel and is adapted to display an image photographed by the image pickup unit 19, a reproduced image of the already recorded image, and setting screens for the functions and modes available in the photographing apparatus 1. Instead of the LCD 5, an organic EL (electroluminescence) display device or a plasma display device may be used.

The setting buttons 6 are buttons operated to start the respective functions available in the photographing apparatus 1.

The direction key 7 includes an annular member having a plurality of pressing portions (triangular portions in FIG. 2) arranged at specified intervals along circumferential direction, and is constructed such that the depression of the pressing portions is detected by unillustrated contact points (switches) provided in correspondence with the respective pressing portions. The push button 8 is disposed in the center of the direction key 7. The direction key 7 and the push button 8 are operated to enter instructions, for example, to advance frames of recorded images to be reproduced on the LCD 5 and to set photographing conditions (aperture value, shutter speed, firing of a flash device).

The optical viewfinder 9 is for optically displaying a range of an object to be photographed. The main switch 10 is a slide switch slidable to left and right and having two contact points, wherein a main power supply of the photographing apparatus 1 is turned on when the main switch 10 is set to left and the main power supply is turned off when the main switch 10 is set to right.

The second mode setting dial 11 has a mechanical construction similar to the first mode setting dial 3 and is for carrying out operations corresponding to various functions available in the photographing apparatus 1. The connection terminal 12 is a terminal for connecting an external device such as an unillustrated flash device with the photographing apparatus 1.

In order to enable secure photographing in the case where a “shake” such as a camera shake is likely to occur during the photographing with a camera hand-held, the telephotographing or the photographing in the dark (a long exposure is necessary), the photographing apparatus 1 of this embodiment is provided with a so-called camera-shake correcting function of correcting a displacement of an optical axis L by suitably moving (pivoting) an optical system for the shake correction and the image pickup unit 19 in accordance with the displacement in the case where a shake such as a shake of a user's hand is imparted to the photographing apparatus 1 to displace an optical axis L.

The photographing apparatus 1 includes a shake detecting sensor 75 (see FIG. 1) at a specified position of the apparatus main body 1A in order to carry out the shake correcting operation. The shake detecting sensor 75 is comprised of an X-sensor 75a for detecting an apparatus shake along X-axis direction and a Y-sensor 75b for detecting an apparatus shake along Y-axis direction if a two-dimensional coordinate system, in which X-axis is defined along horizontal direction of FIG. 1 and Y-axis is defined along vertical direction, is assumed. The X-sensor 75a and the Y-sensor 75b are, for example, gyroscopes for detecting angular velocities of the shakes in the respective directions.

A shake correction ON/OFF button 68 is a button for alternatively selecting a shake correction mode in which a shake correcting operation to be described later is performed against an apparatus shake having occurred to the photographing apparatus 1 and a non-shake correction mode in which no shake correcting operation is performed.

In the case where the shake correcting mode is set, an amount and a direction of the apparatus shake are detected by the shake detecting sensor 75 and a correction amount against this shake is calculated during the photographing standby period started when the shutter button 4 is pressed halfway, whereas a shake correcting operation by a shake correcting mechanism (including the image pickup unit 19 to be described later) is performed in addition to the above operations during an image pickup processing started by fully pressing the shutter button 4.

As shown in FIG. 3, the optical viewfinder 9, an AF driving unit 15, the image pickup unit 19, a shutter unit 40, a mirror box 41, an AF module 46 and a central controller 50 are provided in the apparatus main body 1A.

The AF driving unit 15 includes an AF actuator 16, an encoder 17 and an output shaft 18. The AF actuator 16 includes a DC motor, a stepping motor, an ultrasonic motor or a like motor as a driving source and an unillustrated speed reducing system for reducing the rotating speed of the motor.

Although not described in detail, the encoder 17 is for detecting a rotated amount transmitted from the AF actuator 16 to the output shaft 18, and the detected rotated amount is used for the calculation of the position of a photographic optical system 51 in the interchangeable lens 2. The output shaft 18 is for transmitting a driving force outputted from the AF actuator 16 to a later-described lens driving mechanism 53 in the interchangeable lens 2.

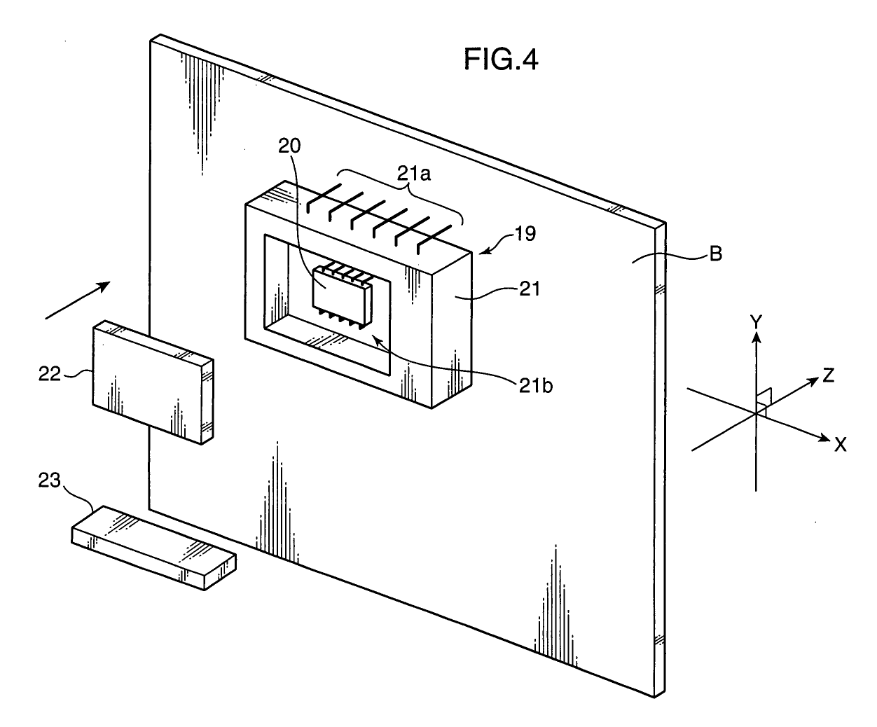

FIG. 4 is an exploded perspective view showing the construction of the image pickup unit 19. The image pickup unit 19 is disposed along the rear surface of the apparatus main body 1A in a rear-surface area, and includes an image pickup device 20, a package 21, a cover glass 22 and a seizing member 23 as shown in FIG. 4.

The image pickup device 20 is, for example, a CMOS (complementary metal-oxide semiconductor) color area sensor having a Bayer array in which a plurality of photoelectric conversion elements such as photodiodes are two-dimensionally arranged in a matrix and color filters of, e.g. R (red), G (green), B (blue) having different spectral characteristics are arrayed at a ratio of 1:2:1 on light receiving surfaces of the respective photoelectric conversion elements. The image pickup device 20 is arranged in the package 21 such that the light receiving surface thereof is substantially parallel to a plane normal to an optical axis of the photographic optical system 51 and is for converting a light image of an object focused by the photographic optical system 51 into analog electrical signals (image signals) of the respective color components R (red), G (green), B (blue) and outputting the resulting signals as image signals of the respective colors R, G, B.

The package 21 is, for example, a rectangular parallelepipedic member made of a material such as a ceramic or a plastic and adapted to accommodate the image pickup device 20. The package 21 includes a plurality of electrodes 21a, which are connected with terminals on a substrate B arranged in an XY-plane if a three-dimensional coordinate system is assumed in which X-axis extends along a direction perpendicular to the plane of FIG. 3, Y-axis extends along vertical direction of FIG. 3 and Z-axis extends along a direction perpendicular to both X-axis and Y-axis (direction of an optical axis L of the photographic optical system 51) in FIG. 3.

The package 21 is formed with a hollow portion 21b rectangular when viewed in Z-axis direction, and the image pickup device 20 and the cover glass 22 are accommodated in this hollow portion 21b.

The cover glass 22 is arranged at the front side of the image pickup device 20 (side toward the photographic optical system 51) in the package 21 and adapted to protect the image pickup device 20 from dust trying to enter the package 21 while introducing the light from the photographic optical system 51 to the image pickup device 20.

In the photographing apparatus 1 of this embodiment, there are cases where dust enters the apparatus main body 1A at the time of mounting and detaching the interchangeable lens 2 since the interchangeable lens 2 is interchangeably mounted on the apparatus main body 1A. Dusts include dirt from the ground, combustion ash by the combustion of objects at factories, combustion ash contained in exhaust gases from automotive vehicles and the like, and fibrous fluffy dust produced from clothes and the like.

The cover glass 22 is provided to protect the image pickup device 20 from the above various dusts. However, since this is disposed on a light path between the photographic optical system 51 and the image pickup device 20, if dust having entered the apparatus main body 1A at the time of mounting or detaching the interchangeable lens 2 is attached to the front face of the cover glass 22, shade and shadow of this dust are reflected in a photographed image, thereby causing a reduction in the quality of the photographed image.

Accordingly, in this embodiment, an electrically conductive coating layer made of, e.g. indium tin oxide (ITO) for reducing the production of electrostatic forces or a dust-attachment preventing coating layer made of a fluorocarbon resin or a silicon resin is formed on the front face of the cover glass 22 to suppress or prevent the attachment of dust to the front face of the cover glass 22, thereby reducing the adherence of dust to the front face of the cover glass 22.

The seizing member 23 for seizing the dust dropped off by a dust removing operation of the image pickup unit driving mechanism 24 to be described later is disposed in the vicinity of the bottom end surface of the cover glass 22. The seizing member 23 is made of a porous material such as sponge and seizes the dust dropped off from the front face of the cover glass 22 by the dust removing operation of the image pickup unit driving mechanism 24, thereby preventing or suppressing the scattering of the dust separated from the front face of the cover glass 22 in the apparatus main body 1A, thus, the reattachment of the dust to the outer surfaces of the cover glass 22, the lens and the like.

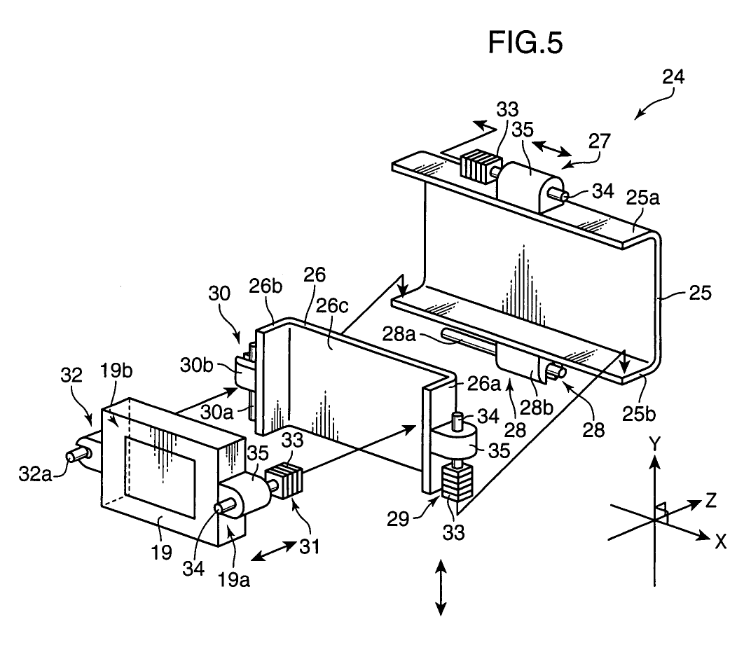

The image pickup unit 19 is driven along the aforementioned respective axial directions by the image pickup unit driving mechanism 24 to be described later. FIG. 5 is a perspective view showing the construction of the image pickup unit driving mechanism 24.

As shown in FIG. 5, the image pickup unit driving mechanism 24 includes a first frame 25, a second frame 26, an X-axis actuator 27, an X-axis guiding portion 28, a Y-axis actuator 29, a Y-axis guiding portion 30, a Z-axis actuator 31 and a Z-axis guiding portion 32.

The first frame 25 is shaped to have a U-shaped cross section by having first and second bent portions 25a, 25b opposed to each other along Y-axis direction. The X-axis actuator 27 is mounted at a specified position of the outer surface of the first bent portion 25a and the X-axis guiding portion 28 is mounted at a specified position of the outer surface of the second bent portion 25b. The second frame 26 is shaped to have a U-shaped cross section by having first and second bent portions 26a, 26b opposed to each other along X-axis direction. The Y-axis actuator 29 is mounted at a specified position of the outer surface of the first bent portion 26a and the Y-axis guiding portion 30 is mounted at a specified position of the outer surface of the second bent portion 26b. The Z-axis actuator 31 is mounted at a specified position of one end surface 19a of the image pickup unit 19 with respect to X-axis direction, whereas the Z-axis guiding portion 32 is mounted at a specified position of an other end surface 19b. The second frame 26 is arranged between the first and second bent portions 25a, 25b of the first frame 25, and the image pickup unit 19 is arranged between the first and second bent portions 26a, 26b of the second frame 26.

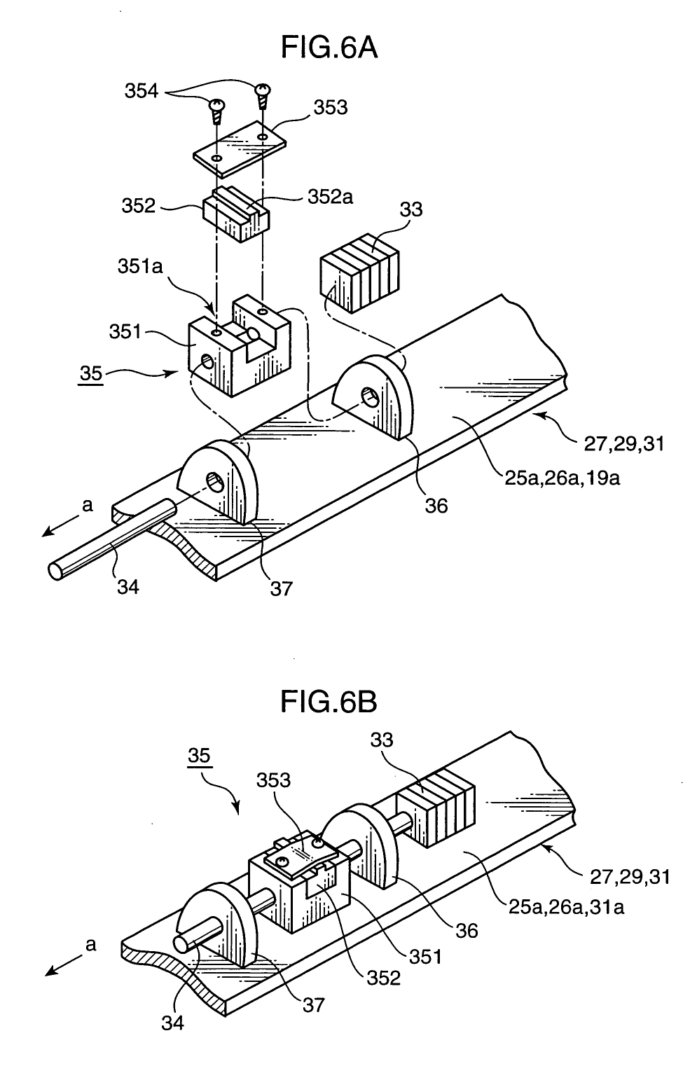

FIGS. 6A and 6B are an exploded perspective view and an assembled perspective view showing the construction of the X-axis actuator 27, the Y-axis actuator 29 and the Z-axis actuator 31.

The X-axis actuator 27, the Y-axis actuator 29 and the Z-axis actuator 31 have substantially similar constructions and each of them includes a piezoelectric element 33, a drive shaft 34 fixed to one end of the piezoelectric element 33 by adhesive, and a frictional coupling portion 35 frictionally coupled to the drive shaft 34 as shown in FIG. 6.

The piezoelectric element 33 is a laminated piezoelectric element constructed by laminating a plurality of ceramic piezoelectric plates made of a material such as barium titanate, lead titanate zirconate. Upon the application of a voltage, this element expands and contracts along a direction of lamination only by an amount corresponding to the applied voltage.

The drive shaft 34 is so supported by supporting members 36, 37 fixed to a flat surface as to be movable along the direction of lamination of the piezoelectric plates forming the piezoelectric element 33. When the piezoelectric element 33 fixed to an end of the drive shaft 34 undergoes expanding and contracting displacements along the thickness direction thereof, the drive shaft 34 moves along longitudinal direction. The flat surface to which the supporting members 36, 37 are fixed is the outer surface of the first bent portion 25a of the first frame 25 for the X-axis actuator 27; the outer surface of the first bent portion 26a of the second frame 26 for the Y-axis actuator 29; and the one end surface 19a of the image pickup unit 19 for the Z-axis actuator 31.

The frictional coupling portion 35 includes a slider 351 letting the drive shaft 34 penetrate therethrough to be frictionally coupled from below, a pad 352 fittable into a notch 351a formed at an upper side of the slider 351 and frictionally coupled to the drive shaft 34 from above, and a leaf spring 353 for adjusting a frictional coupling force between the drive shaft 34 and the slider 351 and the pad 352. A projection 352a formed on the pad 352 is held in contact with the leaf spring 353, and the frictional coupling force can be adjusted by adjusting fastening forces of screws 354 used to fix the leaf spring 353 to the slider 351. On the bottom surface of the slider 351, the frictional coupling portion 35 is fixed by adhesive to the first frame 25, the second frame 26 and the image pickup unit 19.

With reference to FIG. 5, also, the piezoelectric element 33 of the X-axis actuator 27 has one end surface thereof mounted at a specified position of the apparatus main body 1A (fixed by adhesive), and the first frame 25 is coupled to the apparatus main body 1A via the frictional coupling of the slider 351 and the drive shaft 34 of the X-axis actuator 27. In this way, the first frame 25 is movable along X-axis direction relative to the apparatus main body 1A.

The piezoelectric element 33 of the Y-axis actuator 29 has one end surface thereof mounted at a specified position of the underside of the second bent portion 25b of the first frame 25 (fixed by adhesive), and the second frame 26 is coupled to the first frame 25 via the frictional coupling of the slider 351 and the drive shaft 34 of the Y-axis actuator 29. In this way, the second frame 26 is movable along Y-axis direction relative to the first frame 25.

The piezoelectric element 33 of the Z-axis actuator 31 has one end surface thereof mounted at a specified position of a flat portion 26c of the second frame 26 (fixed by adhesive), and the image pickup unit 19 is coupled to the second frame 25 via the frictional coupling of the slider 351 and the drive shaft 34 of the Z-axis actuator 31. In this way, the image pickup unit 19 is movable along Z-axis direction relative to the second frame 26.

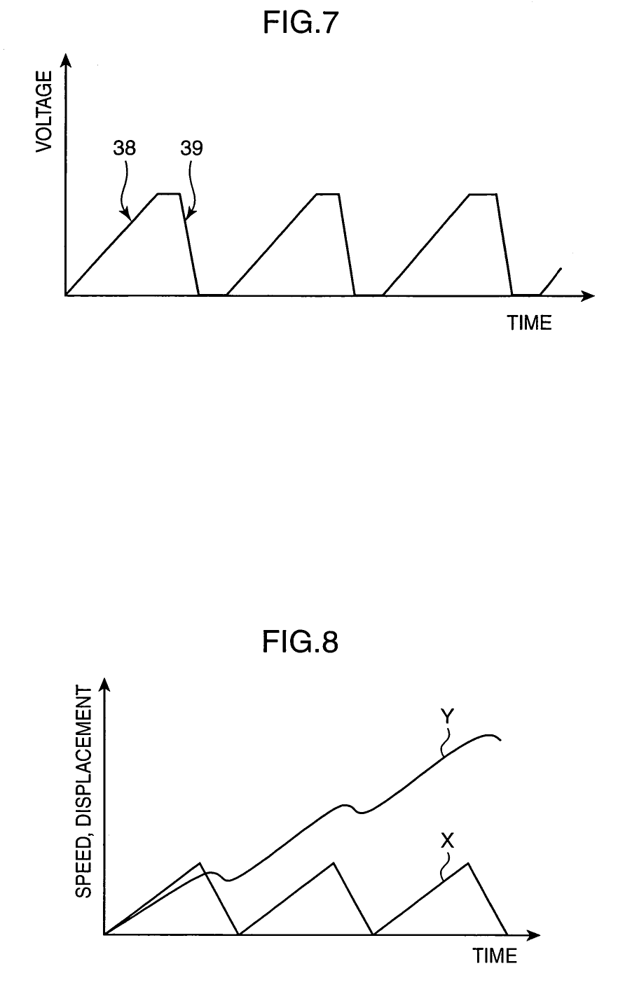

A drive pulse having such a waveform comprised of moderate up portions 38 and successive steep down portions 39 as shown in FIG. 7 is applied to the piezoelectric element 33 of each of the X-axis actuator 27, the Y-axis actuator 29 and the Z-axis actuator 31. The piezoelectric element 33 undergoes a moderate expanding displacement along thickness direction at the moderate up portions 38 of the drive pulse, whereby the drive shaft 34 is displaced in a direction of arrow “a”(see FIGS. 6A and 6B). The direction of arrow “a” corresponds to X-axis direction for the X-axis actuator 27; Y-axis direction for the Y-axis actuator 29; and Z-axis direction for the Z-axis actuator 31.

The piezoelectric element 33 undergoes a steep contracting displacement along thickness direction at the steep down portions 39 of the drive pulse, whereby the drive shaft 34 is displaced in a direction opposite to the direction of arrow “a”. At this time, the frictional coupling portion 35 and the first frame 25, the second frame 26 or the image pickup unit 19 coupled to the frictional coupling portion 35 substantially stay at their positions because an initial force acting thereon becomes larger than the frictional coupling force acting between the drive shaft 34 and the frictional coupling portion 35.

In FIG. 8, a curve X represents a change in the expanding/contracting speeds of the piezoelectric element 33 with time and a curve Y represents a change in a displacement of the frictional coupling portion 35 (slider 351) with time. As shown by the curve X of FIG. 8, the expanding/contracting speed of the piezoelectric element 33 is changed to define, for example, such a triangular waveform such that the piezoelectric element 33 expands at a slower rate than contracting, with the result that the displacement of the frictional coupling portion 35 (slider 351) increases substantially stepwise as shown by the curve Y.

In this way, the image pickup unit 19 can be continuously moved along X-axis direction, Y-axis direction and Z-axis direction by continuously applying the drive pulses having the above waveform. In other words, by applying the above drive pulse to the piezoelectric element 33 of the X-axis actuator 27, the first frame 25 is moved in (+)X-axis direction and the second frame 26 and the image pickup unit 19 directly or indirectly coupled to the first frame 25 are also moved in (+)X-axis direction together with the first frame 25.

Further, by applying the above drive pulse to the piezoelectric element 33 of the Y-axis actuator 29, the second frame 26 is moved in (+)Y-axis direction and the image pickup unit 19 coupled to the second frame 26 is moved in (+)Y-axis direction together with the second frame 26. By applying the drive pulse to the piezoelectric element 33 of the Z-axis actuator 31, the image pickup unit 19 is moved in (+)Z-axis direction.

Further, movements of the image pickup unit 19 in negative directions along the X-axis, Y-axis and Z-axis, i.e. directions opposite to the directions of arrow “a” can be attained by applying a drive pulse having a waveform as above while reversing the polarities of the electrodes of the piezoelectric element 33.

By the above construction, if the shake correction mode is set by the shake correction ON/OFF button 68, a voltage corresponding to the detection result of the shake detecting sensor 75 is applied to the piezoelectric elements 33 of the X-axis actuator 27 and the Y-axis actuator 29 to stabilize the position of the image pickup unit 19 relative to an object light image introduced by the photographic optical system 51, and the first frame 25 is driven along X-axis direction relative to the photographic optical system 51 by the X-axis actuator 27 and the second frame 26 is driven along Y-axis direction relative to the first frame 25 by the Y-axis actuator 27, whereby the image pickup unit 19 is moved along X-axis direction and Y-axis direction.

The photographing apparatus 1 of this embodiment is characterized by being equipped with a function of imparting vibration to the image pickup unit 19 to remove dust if the attachment of the dust to the outer surface of the image pickup unit 19 is detected, by utilizing the X-axis actuator 27 and the Y-axis actuator 29 used for the camera shake correction in the case of carrying out the dust removing operation, and by including the X-axis actuator 27, the Y-axis actuator 29 and the Z-axis actuator 31 to impart vibration along Z-axis direction to the image pickup unit 19.

Unillustrated electrode portions of the piezoelectric elements 33 are connected with unillustrated signal lines of the later-described central controller 50 (see FIG. 10) disposed on the substrate B (see FIG. 4), and the drive pulses are applied from the central controller 50 via the signal lines. The respective actuators 27, 29, 31 drop off the dust, which remains to be attached to the front face of the cover glass 22 despite the presence of the dust-attachment preventing coating layer formed on the cover glass 22, from the front face of the cover glass 22 by imparting rapid displacements (vibration or impact) to the cover glass 222 using characteristics of these piezoelectric elements 33.

Specifically, powder particles (small-size dust) are generally said to attach by electrostatic forces, intermolecular forces, liquid crosslinking forces or the like. As the particles become smaller in size, a ratio of the surface area to the mass of the particles becomes larger and the aforementioned electrostatic forces and the like are proportional to the surface-area. Therefore, small-size dust is likely to attach to the cover glass 22.

If an attempt is made to impart a rapid displacement (impact) to the cover glass, an inertial force trying to stay at the current position acts on the dust attached to the cover glass 22. Since the intensity of this inertial force is proportional to the mass of the particles and acceleration, the dust can be dropped off by imparting a displacement (impact) of such acceleration as to make the inertial force acting on the dust larger than the adherence.

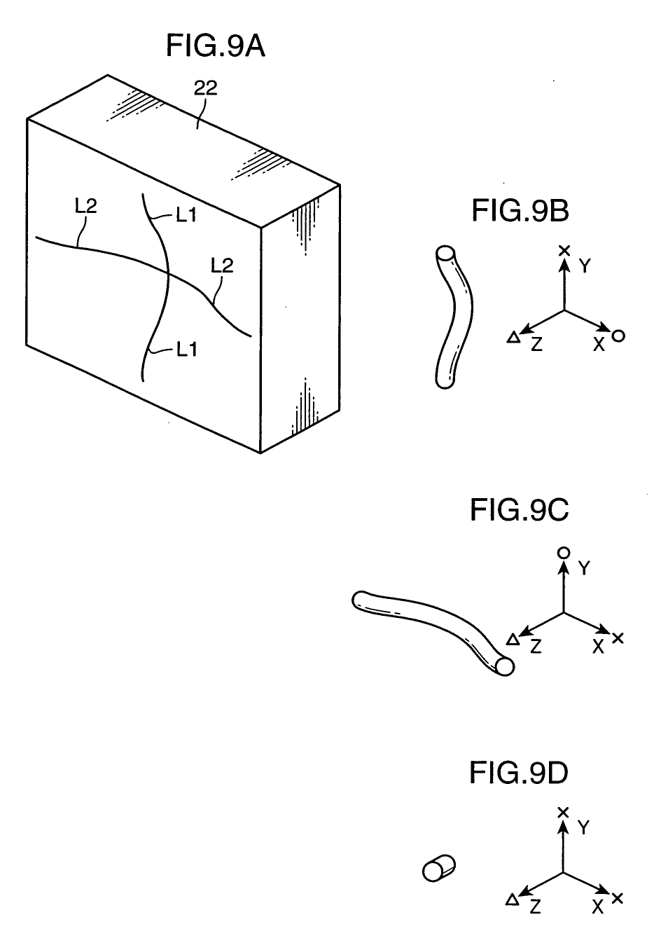

Since the adherence is smaller in a direction parallel to the attached surface of the dust (shear direction) than in perpendicular direction, it is desirable to produce the inertial force in this shear direction. FIGS. 9A to 9D are diagrams showing a concept of a removal capability in the case where dusts are attached to a minute concave surface on the front face of the cover glass 22, wherein FIG. 9A shows a state where a vertically extending valley line L1 and a transversely extending valley line L2 are created on the front face of the cover glass 22 while crossing each other, and FIGS. 9B to 9D show the shapes and attached states of dusts attached to these valley lines L1, L2 and the removal capabilities in the case where vibrations are imparted along the respective axial directions in correspondence with the shapes and attached states of the dusts.

As shown in FIG. 9B, in the case where dust long along the valley line L1 is attached to the valley line L1, it is difficult to remove the dust even if vibration is imparted along vertical direction (Y-axis direction) since movements thereof are restricted, whereas the dust can be easily removed if vibration is given along transverse direction (X-axis direction) since an inertial force is produced in the shear direction with respect to the attached surface.

Further, as shown in FIG. 9C, in the case where dust long along the valley line L2 is attached to the valley line L2, it is difficult to remove the dust even if vibration is imparted along transverse direction (X-axis direction) since movements thereof are restricted, whereas the dust can be easily removed if vibration is given along vertical direction (Y-axis direction) since an inertial force is produced in a shear direction with respect to the attached surface.

Further, as shown in FIG. 9D, in the case where particulate dust is attached at the intersection of the valley lines L1 and L2, it is difficult to remove the dust even if vibration is imparted along either one of vertical and transverse directions (X-axis direction and Y-axis direction), whereas the dust can be removed if vibration is imparted along forward and backward directions (Z-axis direction).

It should be noted that “∘”, “Δ”, “X”, represent degrees of removal capability in FIGS. 9A to 9D, where “∘” represents a highest removal capability and “X” represents a lowest removal capability.

In this way, the direction of vibration capable of giving a high removal capability differs depending on the shapes of the valley lines L1, L2 produced in the front face of the cover glass 22 and the shapes and attached states of the dusts attached to the valley lines L1, L2. Thus, this embodiment is provided with a structure for imparting vibrations along three axial directions to the cover glass 22 to more securely remove the dust regardless of the shape and the attached state of the dust and the surface state of the cover glass 22.

The applicant of the present application got a knowledge that dirt and fluffy dust could be satisfactorily removed by imparting vibration having a vibration amplitude of 1 μm or higher and a vibration frequency of 10 kHz or higher for one second along each direction, preferably by imparting vibration having a vibration amplitude of 3 μm or higher and a vibration frequency of 40 kHz or higher for one section along each direction.

However, since the frequency of the camera shake is generally as low as about 10 kHz, there are some cases where it is difficult to create vibration satisfying the aforementioned conditions by the camera shake correcting mechanism. In such a case, the vibration amplitude may be set at the amplitude value while being prioritized over the vibration frequency and vibration having this amplitude value and a maximum vibration frequency that the camera shake correcting mechanism can output may be created and imparted to the cover glass 22.

Referring back to FIG. 5, the X-axis guiding portion 28 includes a guide bar 28a having one end thereof mounted on the apparatus main body 1A, and an engaging member 28b having a U-shaped cross section, mounted at a specified position of the outer surface of the second bent portion 25b of the first frame 25 and having an engaging groove engageable with the guide bar 28a. The engaging member 28b slides while being engaged with the guide bar 28a, thereby guiding movements of the first frame 25 relative to the apparatus main body 1A along X-axis direction and also preventing the first frame 25 from being rotated about the drive shaft 34 of the X-axis actuator 27.

The Y-axis guiding portion 30 includes a guide bar 30a having one end thereof mounted at a specified position of the underside of the second bent portion 25b of the first frame 25, and an engaging member 30b having a U-shaped cross section, mounted at a specified position of the outer surface of the second bent portion 26b of the first frame 26 and having an engaging groove engageable with the guide bar 30a. The engaging member 30b slides while being engaged with the guide bar 30a, thereby guiding movements of the second frame 26 relative to the first frame 25 along Y-axis direction and also preventing the second frame 26 from being rotated about the drive shaft 34 of the Y-axis actuator 29.

The Z-axis guiding portion 32 includes a guide bar 32a having one end thereof mounted at a specified position of the flat portion 26c of the second frame 26, and an engaging member 32b having a U-shaped cross section, mounted at a specified position of the other end surface 19b of the image pickup unit 19 and having an engaging groove engageable with the guide bar 32a. The engaging member 32b slides while being engaged with the guide bar 32a, thereby guiding movements of the image pickup unit 19 relative to the second frame 26 along Z-axis direction and also preventing the image pickup unit 19 from being rotated about the drive shaft 34 of the Z-axis actuator 31.

Referring back to FIG. 3, the shutter unit 40 includes a focal-plane shutter (hereinafter, merely “shutter”), and is disposed between the rear surface of the mirror box 41 and the image pickup unit 19.

The optical viewfinder 9 is disposed atop the mirror box 41 disposed substantially in the center of the apparatus main body 1A and includes a focusing glass 42, a prism 42, an eyepiece lens 44 and a viewfinder display device 45. The prism 43 is for transversely reversing an image on the focusing glass 42 and introducing the reversed image to photographer's eyes via the eyepiece lens 44 in order to enable the visual confirmation of an object image. The viewfinder display device 45 is for displaying a shutter speed, an aperture value, exposure correction values and the like below a display screen formed within a viewfinder field of view frame 9a (see FIG. 2).

The AF module 46 is disposed below the mirror box 41 and is for detecting an in-focus position by a phase-difference detecting method, which is a known technology.

The mirror box 41 is comprised of a quick return mirror 47 and a submirror 48. The quick return mirror 47 is rotatable between a posture inclined about 45° with respect to the optical axis L of the photographic optical system 51 (hereinafter, “inclined posture”) as shown by solid line in FIG. 3 and a posture substantially parallel to the bottom surface of the apparatus main body 1A (hereinafter, “horizontal posture”) as shown by phantom line in FIG. 3 about a supporting point of rotation 49.

The submirror 48 is disposed at the underside (at a side toward the image pickup unit 19) of the quick return mirror 47, and is displaceable between a posture inclined about 90° with respect to the quick return mirror 48 in the inclined posture as shown by solid line in FIG. 3 (hereinafter, “inclined posture”) and a posture substantially parallel to the quick return mirror 47 in the parallel posture as shown by phantom line in FIG. 3 (hereinafter, “parallel posture”), as the quick return mirror 47 is rotated. The quick return mirror 47 and the submirror 48 are driven by a mirror driving mechanism 59 (see FIG. 10) to be described later.

During a period until the shutter button 4 is fully pressed, the quick return mirror 47 and the submirror 48 assume their inclined postures, wherein the quick return mirror 47 reflects most of a beam from the photographic optical system 51 in a direction toward the focusing glass 42 while permitting the remaining beam to transmit therethrough, and the submirror 48 introduces the beam having transmitted through the quick return mirror 47 to the AF module 46. At this time, the display of the object image by the optical viewfinder 9 and the focusing by the AF module 46 according to the phase-difference detecting method are performed, whereas the display of the object image by the LCD 5 is not performed since no beam is introduced to the image pickup unit 19.

On the other hand, when the shutter button 4 is fully pressed (during an image pickup operation for an image to be recorded), the quick return mirror 47 and the submirror 48 assume their parallel postures, wherein the substantially entire beam having transmitted through the photographic optical system 51 is introduced to the image pickup unit 19 since the quick return mirror 47 and the submirror 48 are retracted from the optical axis L. At this time, the display of the object image by the LCD 5 is performed, whereas neither the display of the object image by the optical viewfinder 9 nor the focusing by the AF module 46 according to the phase-difference detecting method is performed.

The central controller 50 is a microcomputer having unillustrated built-in storage devices to be described later such as a ROM storing a control program and a flash memory for temporarily saving data, and functions thereof are described in detail later.

Next, the interchangeable lens 2 to be mounted on the apparatus main body 1A is described. As shown in FIG. 3, the interchangeable lens 2 is provided with the photographic optical system 51, a barrel 52, the lens driving mechanism 53, a lens encoder 54 and a storage device 55 as shown in FIG. 3.

The photographic optical system 51 is constructed such that a zoom lens 13 (see FIG. 10) for changing a photographing magnification (focal length), a focusing lens 14 (see FIG. 10) for adjusting a focal position, and an aperture diaphragm 56 for adjusting an amount of light to be incident on the image pickup unit 19 and the like to be described later provided in the apparatus main body 1A are held in the barrel 52 while being arranged along the direction of the optical axis L, and is adapted to obtain a light image of an object and focus the obtained light image on the image pickup unit 19 and the like. The focusing is performed by driving the photographic optical system 51 along the direction of the optical axis L by means of the AF actuator 16 in the apparatus main body 1A. It should be noted that the photographing magnification (focal length) is manually changed (zooming is manually performed) by means of the unillustrated operation ring as described above.

The lens driving mechanism 53 includes, for example, a helicoid, an unillustrated gear for rotating the helicoid and the like, and moves the photographic optical system 51 integrally in directions of arrows A parallel to the optical axis L upon receiving a driving force from the AF actuator 16 via a coupler 57. A moving direction and a moving amount of the photographic optical system 51 conform to a rotating direction and a rotating speed of the AF actuator 16.

The lens encoder 54 includes an encoder plate on which a plurality of code patterns are formed at specified intervals along the direction of the optical axis L within a movable range of the photographic optical system 51, and an unillustrated encoder brush integrally movable with the barrel 52 while being held in sliding constant with the encoder plate, and is for detecting a moved amount of the photographic optical system 51 during the focusing.

The storage device 55 provides the central controller 50 in the apparatus main body 1A with memory content if the interchangeable lens 2 is mounted on the apparatus main body 1A and a data request is made by the central controller 50 in the apparatus main body 1A. The storage device 55 stores information on the moved amount of the photographic optical system 51 outputted from the lens encoder 54, the current aperture diameter of the diaphragm 56 and the like.

Next, the electrical construction of the photographing apparatus 1 according to this embodiment is described. FIG. 10 is a block diagram showing the electrical construction of the entire photographing apparatus 1 with the interchangeable lens 2 mounted on the apparatus main body 1A. The same members as those in FIGS. 1 to 9 are identified by the same reference numerals. Dotted line in FIG. 10 indicates members installed in the interchangeable lens 2.

As shown in FIG. 10, a photographic optical system 51 corresponds to the one shown in FIG. 3 and includes the aforementioned zoom lens 13 and the focusing lens 14 in the barrel 52. An AF actuator 16, an output shaft 18, a lens driving mechanism 53 and a lens encoder 54 correspond to those shown in FIG. 3. A storage device 55 corresponds to the one shown in FIG. 3. A mirror unit 58 includes a quick return mirror 47 and a submirror 48, and an AF module 46 corresponds to the one shown in FIG. 3.

An image pickup unit 19 corresponds to the one shown in FIGS. 3 and 4, and an image pickup operation thereof including the start and the end of an exposing operation of an image pickup device 20 and the readout of output signals of pixels of the image pickup device 20 (horizontal synchronization, vertical synchronization, transfer) is controlled by a timing control circuit.

The mirror driving mechanism 59 is for driving the quick return mirror 47 and the submirror 48 between inclined postures and parallel postures and the operation thereof is controlled by the central controller 50.

A signal processor 60 is for applying a specified analog signal processing to analog image signals outputted from the image pickup unit 19. The signal processor 60 includes a CDS (correlated double sampling) circuit and an AGC (automatic gain control) circuit, wherein noise of an image signal is reduced by the CDS circuit and the level thereof is adjusted by the AGC circuit.

An A/D (analog-to-digital) converter 61 is for converting analog pixel signals of R, G, B outputted from the signal processor 60 into digital pixel signals each comprised of a plurality of bits (e.g. 10 bits). Hereinafter, the pixel signals after the A/D conversion by the A/D converter 61 are referred to as pixel data in order to be distinguished from the analog pixel signals.

The timing control circuit 62 generates clocks CLK1, CLK2 based on a reference clock CLK0 outputted from the central controller 50 and outputs the clock CLK1 to the image pickup unit 19 and the clock CLK2 to the A/D converter 61, thereby controlling the operations of the image pickup unit 19 and the A/D converter 61.

An image memory 63 is a memory in which an image data outputted from an image processor 64 is temporarily saved and which is used as a work area for applying various processings to the image data by means of the central controller 50 in the photographing mode, and in which an image data read from an external storage device 66 to be described later by the central controller 50 is temporarily saved in the reproduction mode.

The image processor 64 is for applying, to the output data from the A/D converter 61, a processing for correcting a black level to a reference black level, a white balance processing for converting the levels of the pixel data of the respective color components R (red), G (green), B (blue) based on a white reference corresponding to a light source, a γ-correction processing for correcting γ-characteristics of the pixel data of the respective color components R (red), G (green), B (blue), and the like processings.

A VRAM (video random access memory) 65 has a memory capacity for an image signal corresponding to the number of pixels of the LCD 5 and serves as a buffer memory for the pixel signals constituting an image to be reproduced on an LCD 5. The LCD 5 corresponds to the one shown in FIG. 2. The external storage device 66 is a memory card, a hard disk or the like including a semiconductor memory element and is for storing an image generated by the central controller 50.

An input operation unit 67 includes the aforementioned first mode setting dial 3, shutter button 4, setting buttons 6, direction key 7, push button 8, main switch 10 and second mode setting dial 11 and is adapted for entering operation information in the central controller 50.

An image pickup unit driving mechanism 24 corresponds to the one shown in FIG. 5.

The photographing apparatus 1 of this embodiment is provided with a function of detecting the presence or absence of dust on the cover glass 22 in addition to the aforementioned function of removing dust attached to the cover glass 22, and an auxiliary light irradiating device 69 to be described below is provided as a structure for realizing such a function. FIG. 11 is a perspective view showing the construction of the auxiliary light irradiating device 69.

As shown in FIG. 11, the auxiliary light irradiating device 69 is comprised of a light emitting portion 70 disposed below the mirror box 41 and including, for example, a LED (light-emitting diode), a lens 71 disposed between the light emitting portion 70 and the quick return mirror 47 for diffusing a light from the light emitting portion 70, and a small mirror 72 provided on the backside of the quick return mirror 47 (surface indicated by arrow S in FIG. 3). The light outputted from the light emitting portion 70 is diffused by the lens 71, and the diffused light is reflected by the small mirror 72 toward the image pickup device 20 to be introduced to a light receiving surface of the image pickup device 20.

The light emitting portion 70 has a sufficiently small size and can be considered as a point light source. The light emitting portion 70, the lens 71 and the small mirror 72 are arranged at such positions that the entire light receiving surface (image pickup surface) of the image pickup device 20 can be irradiated with the light from the light emitting portion 70 when the quick return mirror 47 assumes the inclined posture (time except the period during which an image pickup operation is performed to record an image). An amount of the light outputted from the light emitting portion 70 is so set as not to cause a phenomenon of whitening an image, which is obtained by the image pickup operation of the image pickup device 20 during the dust detection to be described later, due to an excessively large luminance, and a spectral distribution thereof is set substantially to that of white light. It should be noted that the small mirror 72 permits rays of light introduced from the photographic optical system 51 via the quick return mirror 47 to transmit therethrough toward the submirror 48.

As shown in FIG. 10, the central controller 50 is for controlling an image pickup operation and a reproducing operation while relating the operations of the respective members in the photographing apparatus 1 shown in FIG. 3 to each other. Further, the central controller 50 is functionally provided with a light transmission calculating section 73 and a dust removal controlling section 74 in relation to the dust removing operation.

Although some of the aforementioned dusts may completely shut off (light transmittance of 0%) the object light introduced from the photographic optical system 51 depending on their kinds and attached amounts, a dust image produced in a photographed image can be thought as an image of the light introduced from the photographic optical system 51, but attenuated by the presence of the dust since only a tiny amount of the light generally transmits through the dust. This embodiment is described, assuming that the dust to be detected and removed is not the one that completely shuts off the light to the light receiving surface of the image pickup device 20, but the one that permits the transmission of part of the light.

The light transmission calculating section 73 is for calculating a ratio of an actual amount of incident light on each pixel to a light amount in the case of being free from the influence of the dust in a state where an amount of incident light on the image pickup unit 19 (cover glass 22) is uniformly distributed over the entire light receiving surface of the image pickup unit 19, in other words, a ratio of a pixel value of each image picked up by each pixel of the image pickup device 20 to a pixel value in the case of being free from the influence of the dust for the position of each pixel in the above state. Hereinafter, this ratio is referred to as a light transmittance.

Specifically, the light transmittance calculating section 73 stores the pixel values (hereinafter, reference pixel values) of the respective pixels when the light emitting portion 70 of the auxiliary light irradiating device 69 is turned on with external light shut off at the time of the shipment of the photographing apparatus 1 (when dust is thought to be hardly attached to the cover glass 22). Thereafter, the light transmittance calculating section 73 turns the light emitting portion 70 on when the main power of the photographing apparatus 1 is turned on, thereby letting the image pickup device 20 to perform the image pickup operation only once to obtain the pixel values of the respective pixels. The light transmittance calculating section 73 divides the pixel values of the respective pixels by the reference pixel values of these pixels and calculate light transmittances by converting these quotients into percentages.

The dust removal controlling section 74 controls dust removing processing to remove the dust attached to the cover glass 2 if there are a specified number or more pixels having the light transmittances equal to or below a predetermined threshold value for the light transmittances calculated by the light transmittance calculating section 73.

In other words, the dust removal controlling section 74 causes the cover glass 22 to be quickly displaced by outputting pulsed drive signals to the respective actuators 27, 29, 31 in the image pickup unit driving mechanism 24 as described above, whereby the dust on the cover glass 22 is dropped off.

Generally, a decreasing rate of the pixel value that can be detected as unevenness is said to be about 3 to 5% if an object image of a uniform color such as gray is picked up. Specifically, if the pixel value of the pixel is lower than that of the other pixels by about 3 to 5%, the image picked up by this pixel can be visually confirmed as unevenness by human eyes. Thus, the above threshold value for the light transmittance used in judging whether or not the dust removal processing by the dust removal controlling section 74 is necessary may be set within a range of 95 to 97% of the pixel values to the pixel values of the pixels not receiving the dust image.

The dust removal processing by the dust removal controlling section 74 may be performed if there is even one pixel whose light transmittance is equal to or below the threshold value. Further, a period during which the cover glass 22 is caused to be quickly displaced may be suitably set.

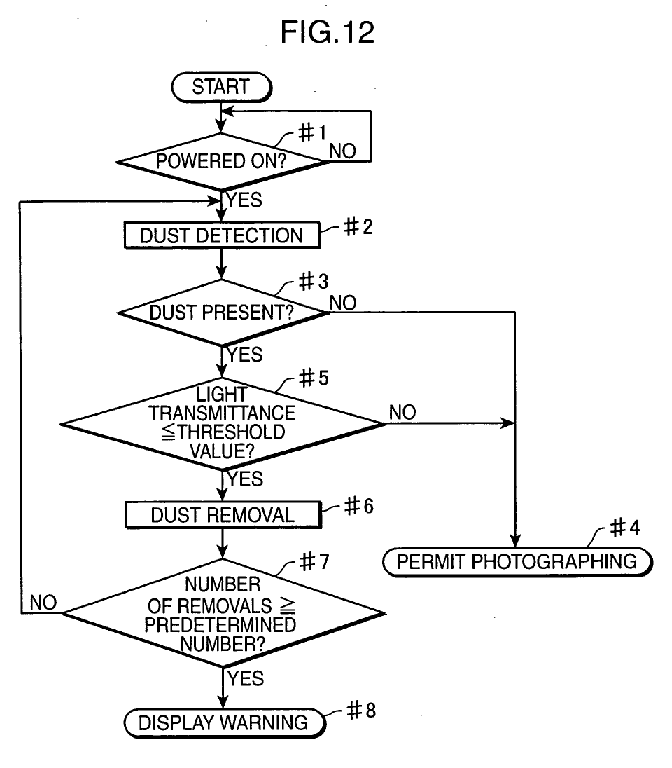

The dust removal processing of this embodiment is described below. FIG. 12 is a flowchart showing the dust removal processing carried out by the central processor 50.

As shown in FIG. 12, when the main power of the photographing apparatus 1 is turned on (YES in Step #1), the central controller 50 carries out a processing for detecting whether or not any dust is attached to the cover glass 22 (Step #2), and permits a photographing operation (Step #4) if no dust is detected (NO in Step #3).

On the other hand, the central controller 50 judges whether or not the light transmittance of each pixel calculated by the light transmittance calculating section 73 is equal to or below the threshold value (Step #5) if any dust is detected (YES in Step #3). If the number of the pixels whose light transmittances equal to or below the threshold value is below a specified number (NO in Step #5), a photographing operation is permitted without carrying out the dust removal processing by judging that the influence on the quality of a photographed image is small (Step #4).

On the other hand, if the number of the pixels whose light transmittances equal to or below the threshold value is the specified number or larger (YES in Step #4), the central controller 50 carries out a processing for removing the dust from the cover glass 22 (Step #6). Then, the central controller 50 judges whether or not the number of the dust removing operations performed has reached a predetermined number (Step #7), and operations in Steps #2 to #7 are repeated if the number of the dust removing operations have not yet reached the predetermined number (NO in Step #7). Further, the central controller 50 causes the LCD 5 to display a warning such as “Dust is present in the apparatus. Clean the interior of the apparatus.” or “Quality of photographed image will be deteriorated by dust in the apparatus.”(Step #8) if the number of the dust removing operations reaches the predetermined number (YES in Step #7).

As described above, since the image pickup unit driving mechanism 24 is provided to impart vibrations along three axial directions to the image pickup unit 19, the dust can be more securely removed regardless of the shape and attached state of the dust and the surface state of the cover glass 22.

Particularly, in this embodiment, the image pickup unit driving mechanism 24 provided for correcting the camera shake is utilized for the vibrations along X-axis direction and Y-axis direction out of those along the above three axial directions. Thus, as compared to a case where a mechanism for imparting vibrations along these two axial directions is separately installed, the cost increase and enlargement of the photographing apparatus 1 can be suppressed by deleting such a mechanism.

In addition to or instead of the foregoing embodiment, the following modifications (1) to (9) may be made.

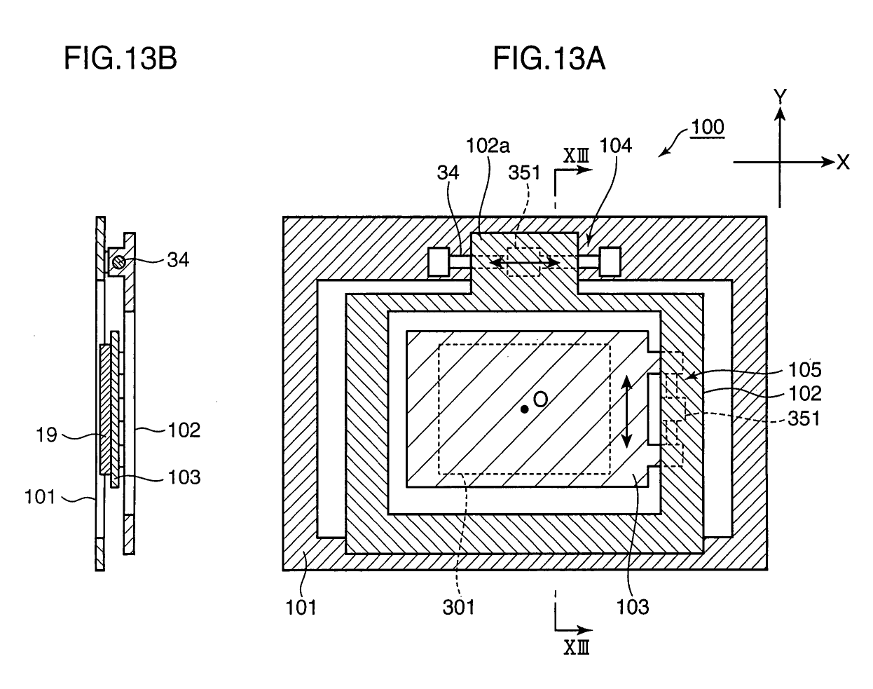

(1) The mode for imparting vibrations to the image pickup unit 19 is not limited to the one of the foregoing embodiment, and may be such as shown in FIGS. 13 to 16.

FIG. 13A and 13B are views showing a construction of a modified image pickup unit driving mechanism 100 for performing a shake correcting operation and a dust removing operation, wherein FIG. 13A is a view of the driving mechanism 100 when viewed from a side (rear side) opposite to the image pickup surface, and FIG. 13B is a sectional view taken along the line XIII-XIII in FIG. 13A. As shown in FIG. 13A, a two dimensional coordinate system (corresponding to the two-dimensional coordinate system set in FIG. 1) having an X-axis and a Y-axis extending along the directions of the respective sides is set for the image pickup surface of the image pickup device 20.

The driving mechanism 100 is provided with a first member 101, a second member 102, a third member 103, which are all substantially rectangular, an X-axis actuator 104 and a Y-axis actuator 105. The first member 101 is a hollow member fixed to the apparatus main body 1A, and the X-axis actuator 104 is mounted at an upper middle position of the rear surface of the first member 101. The second member 102 is a hollow member coupled to the X-axis actuator 104. The Y-axis actuator 105 is mounted at a middle position of one side of the front surface of the second member 102. The third member 103 is a plate-like member coupled to the Y-axis actuator 105, and a casing 201 to be described later housing the image pickup unit 19 is fixedly attached to the front surface of the third member 103. The second member 102 and the third member 103 have movements thereof along X-axis direction and Y-axis direction guided by unillustrated rail members at specified positions. The X-axis actuator 104 and the Y-axis actuator 105 have constructions similar to those of the aforementioned X-axis actuator 27 and Y-axis actuator 29.

The second member 102 has a projecting portion 102a projecting upward at a middle position of the upper edge, and a slider 351 (see FIG. 6) is integrally formed on a surface of the projecting portion 102a toward the first member 101. The first member 101 and the second member 102 are coupled by frictional coupling between the slider 351 and a drive shaft 34 (see FIG. 6) of the X-axis actuator 104, whereby the second member 102 is moveable along X-axis direction relative to the first member 101.

Further, a slider 351 is integrally formed at a middle position on a surface of one lateral side of the second member 102 toward the first member 101. The third member 103 and the second member 102 are coupled by frictional coupling between the slider 351 and a drive shaft 34 of the Y-axis actuator 105, whereby the third member 103 is movable along Y-axis direction relative to the second member 102.

By continuously applying the drive pulses shown in FIG. 7 to the X-axis actuator 104 and the Z-axis actuator 105, the casing 201 is moved along X-axis direction and Y-axis direction by the same mechanism as in the first embodiment.

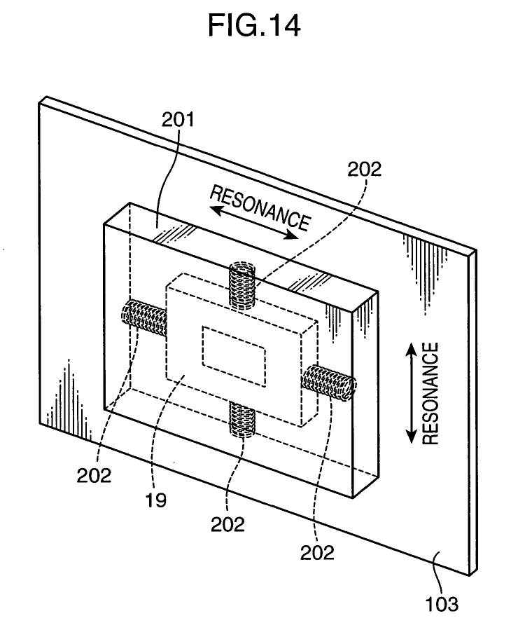

FIG. 14 is a perspective view showing the construction for imparting vibrations to the image pickup unit 19 using the driving mechanism 100 shown in FIGS. 13A and 13B. The image pickup unit 19 and, for example, coil springs 202 as biasing members disposed between end surfaces of the casing 201 and end surfaces of the image pickup unit 19 are provided in the casing 201 fixedly attached to the front surface of the third member 103. At least the front surface of the casing 201 is open or made of a transparent material.

Vibration is induced in the casing 201 by causing the casing 201 to resonate at a specified resonance frequency by means of the driving mechanism 100, and the vibration of the casing 201 is imparted as vibration to the image pickup unit 19 via the coil springs 202.

According to this mode, a large vibration amplitude can be obtained for the image pickup unit 19 since resonance is utilized. As a result, a high dust removal capability can be ensured and the vibration amplitude of the driving mechanism 100 (expanding and contracting amounts of the piezoelectric elements 33) can be suppressed, wherefore a reduction in the durability of members due to the abrasion of the drive shafts 34 and the frictional coupling portions 35 and the like can be suppressed.

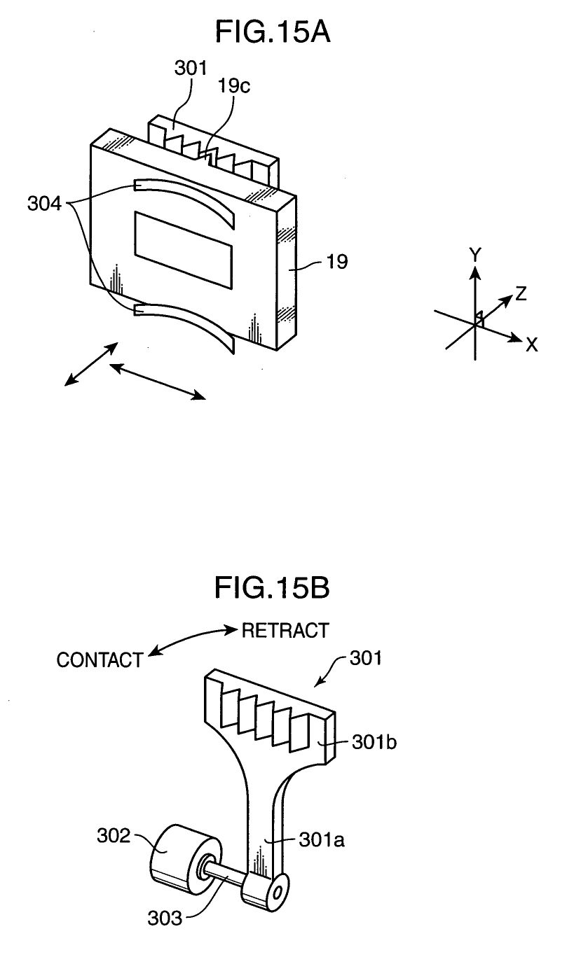

In a vibration imparting structure shown in FIG. 15A, the image pickup unit 19 is not adhered to the third member 103, but a movable body 301 is provided between the rear surface of the image pickup unit 19 and the third member 103 and a projection 19c having a triangular cross section is formed on a surface (rear surface) of the image pickup unit 19 facing the movable body 301 in the case where the driving mechanism is provided. As shown in FIG. 15B, the movable body 301 is a member having an elongated portion 301a and an interlocking portion 301b formed at the leading end of the elongated portion 301a. The interlocking portion 301b has a plurality of triangular projections arranged one after another along X-axis direction in a section along an X-Z plane. The movable body 301 can be driven by, for example, a pulse motor 302 as a driving portion between a contact position where the movable body 301 is in contact with the image pickup unit 19 and a released position where the movable body 301 is released from the contact with the image pickup unit 19 about a rotary shaft 303 in parallel with the X-axis. The movable body 301 is movable independently of movements of the third member 103 without being coupled to the third member 103.

As shown in FIG. 15A, the image pickup unit 19 is supported on the third member 103 by a specified supporting structure, and is biased toward the third member 103 by, for example, leaf springs 304 as biasing members.

According to this construction, the image pickup unit 19 is moved along X-axis direction by the aforementioned driving mechanism 100 after the movable body 301 is brought into contact with the image pickup unit 19 by the pulse motor 302, whereby the projection 19c slides on the interlocking portion 301b of the movable body 301. As a result, the image pickup unit 19 vibrates along Z-axis direction in accordance with the projections of the interlocking portion 301b.

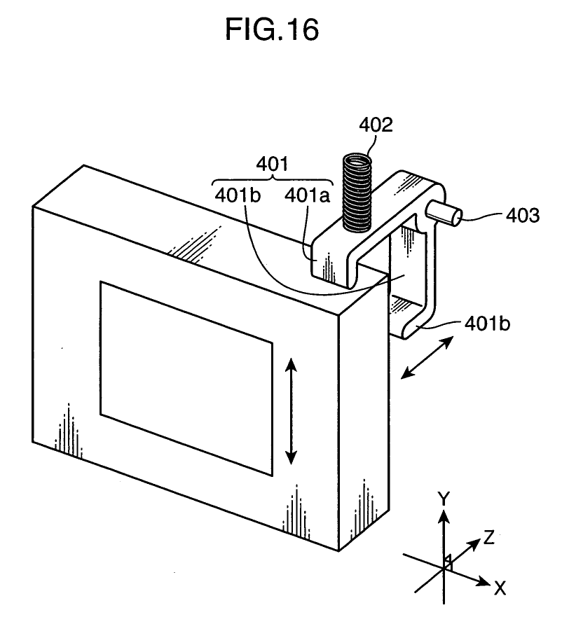

FIG. 16 is a perspective view showing the construction in which an L-shaped arm 401 rotatable about a rotary shaft 403 in parallel with the X-axis is provided between the image pickup unit 19 and the third member 103 instead of the movable body 301 shown in FIGS. 15A and 15B and, when the image pickup unit 19 is moved along Y-axis direction, it is moved along Z-axis direction using such a movement along Y-axis direction.

Specifically, as shown in FIG. 16, the leading end of a first arm portion 401a of the arm 401 is bent toward the top surface of the image pickup unit 19 and this bent leading end is held in contact with the top surface of the image pickup unit 19 at a specified position, whereas the leading end of a second arm portion 401b is bent toward a side surface of the image pickup unit 19 and this bent leading end is held in contact with this side surface of the image pickup unit 19 at a specified position. Further, the first arm portion 401a is biased from above by, for example, a coil spring 402 as a biasing member. When the image pickup unit 19 is driven upward along Y-axis direction by the aforementioned driving mechanism 100, the arm 401 is rotated about the rotary shaft 403, with the result that the image pickup unit 19 is pushed forward along Z-axis direction (toward the photographic optical system 51) by the bent portion of the second arm portion 401b.

When the image pickup unit 19 is driven downward along Y-axis direction by the driving mechanism 100 in this state, the arm 401 is rotated about the rotary shaft 403 with the bent portion of the first arm portion 401a held in contact with the top surface of the image pickup unit 19 at the specified position as the image pickup unit 19 is moved downward by a biasing force of the coil spring 402.

When vibration is imparted in Y-axis direction to the image pickup unit 19 by the driving mechanism 100, vibration is imparted in Z-axis direction to the image pickup unit 19 by the action of the arm 401.

The constructions shown in FIGS. 15 and 16 can both realize the miniaturization and cost reduction of the photographing apparatus 1 because the driving mechanism (such as the aforementioned Z-axis actuator) for driving the image pickup unit 19 along Z-axis direction is not necessary.

(2) The vibrations imparted along the respective axial directions may be substantially the same vibrations, i.e. vibrations having the same vibration cycle, vibration amplitude and phase or at least one of them may be a different vibration. Further, the vibrations may be simultaneously imparted along the respective axial directions or may be individually imparted along the respective axial directions.

The direction of an inertial force that makes the dust easier to drop off differs depending on a relationship between the attached position of the dust in contact with the image pickup unit 19 and the center of gravity of the dust, the shape of the dust and the like. Accordingly, if the image pickup unit 19 is moved, for example, along a rectangular or polygonal route so that inertial forces act in a plurality of directions, a possibility of dropping the dust off the cover glass 22 can be increased.

Accordingly, by simultaneously imparting the vibrations along two of the three axial directions or along the three axial directions, for example, in the first embodiment, the image pickup unit 19 may be moved in an oblique direction intersecting with both X-axis direction and Y-axis direction or may be moved along a route having a circular shape, a rectangular shape, a polygonal shape or one of various other shapes.

(3) Instead of the driving method using the frictional coupling as in the first embodiment, vibrations may be imparted to the image pickup unit 19 merely by directly transmitting expanding and contracting motions (vibrations) of the piezoelectric elements with the piezoelectric elements directly held in contact with the image pickup unit 19 at specified positions.

(4) In the construction for imparting the vibrations to the image pickup unit 19 for the dust removing operation by the driving mechanism utilizing the frictional coupling between the drive shafts 34 and the frictional coupling portions 35, there is a durability problem of members due to the abrasion between the drive shafts 34 and the frictional coupling portions 35. Accordingly, if vibration for the dust removing operation is transmitted to the image pickup unit 19 outside a camera shake correction range by the driving mechanism, local abrasion can be avoided since the frictionally coupled positions of the drive shafts 34 and the frictional coupling portions 35 differ between during the transmission of the vibration and during the camera shake correction. Therefore, the bad influence on the camera shake correcting operation can be prevented or suppressed.

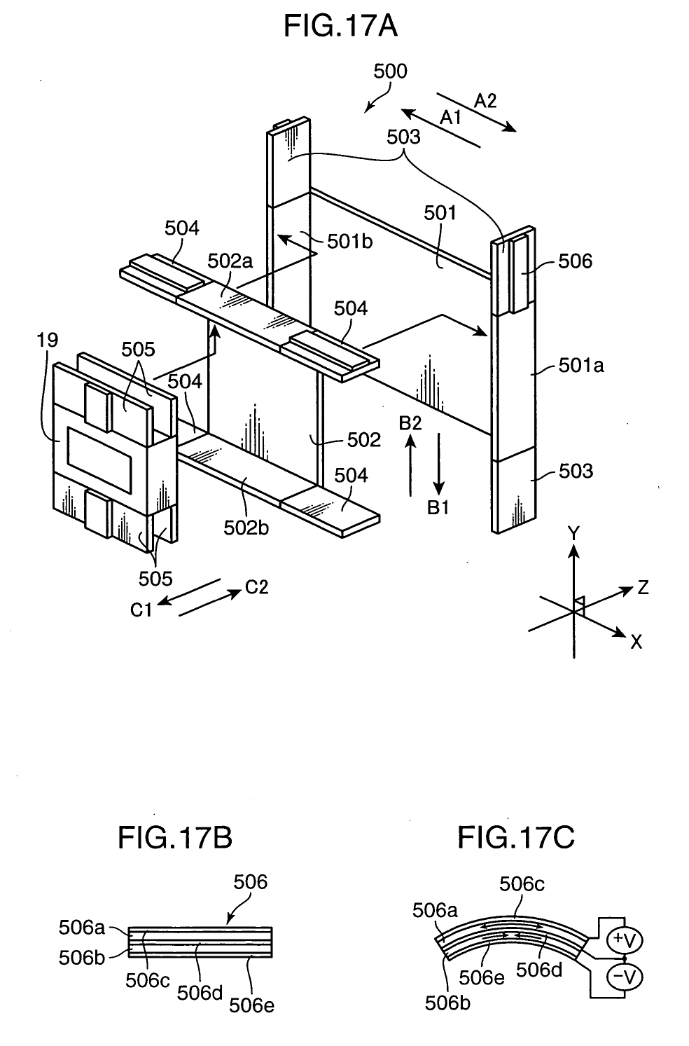

(5) The construction for driving the image pickup unit 19 along the three axial directions is not limited to the image pickup unit driving mechanism 24 shown in FIG. 5 and may be, for example, as follows. FIGS. 17A to 17C are diagrams showing the construction of a modification (image pickup unit driving mechanism 500) of the image pickup unit driving mechanism. It should be noted that the same member as the one in the first embodiment is not described by being identified by the same reference numeral.

As shown in FIG. 17A, the image pickup unit driving mechanism 500 is provided with a first frame 501, a second frame 502, first elastic plates 503, second elastic plates 504 and third elastic plates 505.

The first frame 501 is a member having a U-shaped cross section and including a first bent portion 501a and a second bent portion 501b facing each other along X-axis direction, whereas the second frame 502 is a member having a U-shaped cross section and including a first bent portion 502a and a second bent portion 502b facing each other along Y-axis direction.

The first to third elastic plates 503 to 505 are elastic in directions in which their plate surfaces are warped. The first elastic plates 503 are mounted on the upper ends and bottom ends of the first and second bent portions 501a, 501b of the first frame 501 while being held in parallel with the plate surfaces of the respective bent portions 501a, 501b. Piezoelectric elements 506 to be described later are fixed attached by adhesive to the outer surfaces of the first elastic plates 503 mounted on the upper ends of the first and second bent portions 501a, 501b.

The second elastic plates 504 are mounted on the left ends and right ends of the first and second bent portions 502a, 502b of the second frame 502 while being held in parallel with the plate surfaces of the respective bent portions 502a, 502b. Piezoelectric elements 506 are fixed by adhesive to the outer surfaces of the second elastic plates 504 mounted on the left and right ends of the first bent portion 502a.

The third elastic plates 505 are mounted on the front and rear edges (opposite edges with respect to Z-axis direction) of the top and bottom surfaces of the image pickup unit 19 while being held in parallel with the front (toward the photographic optical system 51) and rear surfaces of the image pickup unit 19, and piezoelectric elements 506 are fixedly attached by adhesive to the outer surfaces of the third elastic plates 505 at the front side.

The second frame 502 is supported by the first frame 501 by having the ends of the second elastic plates 504 brought into contact with the first and second bent portions 501a, 501b of the first frame 501 to be held in position with specified forces given from the first frame 501 and acting in opposite directions. The image pickup unit 19 is supported by the second frame 502 by having the ends of the third elastic plates 505 brought into contact with the first and second bent portions 502a, 502b of the second frame 502 to be held in position with specified forces given from the second frame 502 and acting in opposite directions.

Each piezoelectric element 506 has a so-called bimorph structure by alternately laminating piezoelectric substrates 506a, 506b having a specified thickness and a plurality of electrode plates 506c, 506d, 506e as shown in FIG. 17B. Although FIG. 17B shows an piezoelectric element constructed by sandwiching the two piezoelectric substrates by three electrode plates, the number of the piezoelectric substrates and that of the electrode plates are not limited to those shown in FIG. 17B.

When voltages are applied to the electrode plates at the opposite sides of the piezoelectric element 506, an expanding/contracting force acts in thickness direction. Here, since the piezoelectric element 506 is an elastic body, an expanding/contracting action occurs in a direction of plane normal to thickness direction, for example, if the piezoelectric element 506 contracts in thickness direction.

For example, when specified voltages are applied (voltages having opposite polarities are applied to the piezoelectric substrates 506a, 506b) with the potential of the middle electrode plate 506d sandwiched between the piezoelectric elements 506a and 506b set at 0, the uppermost electrode plate 506c acting as a positive pole (+V) and the bottommost electrode plate 506e acting as a negative pole (−V) out of three electrode plates 506c, 506d, 506e as shown in FIG. 17C, the piezoelectric substrate 506a becomes thinner, thereby expanding in a direction of plane orthogonal to the thickness direction of the piezoelectric substrate 506a. On the other hand, the lower piezoelectric substrate 506b becomes thicker, thereby contracting in a direction of plane orthogonal to the thickness direction of the lower piezoelectric substrate 506b. As a result, the piezoelectric element 506 is so warped that a middle part thereof with respect to a transverse direction of FIG. 17C projects upward. Further, by reversing the polarities of the voltages applied to the piezoelectric substrates 506a, 506b, the piezoelectric element 506 is so warped that the transverse middle part thereof projects downward.

The piezoelectric elements 506 having the above construction are mounted on the plate surfaces of the elastic plates 503 to 505 such that the laminated directions substantially coincide with directions normal to the plate surfaces of the first, second and third elastic plates 503, 504, 505. Accordingly, the first, second and third elastic plates 503, 504, 505 are deformed to be warped as the piezoelectric elements 506 are warped.

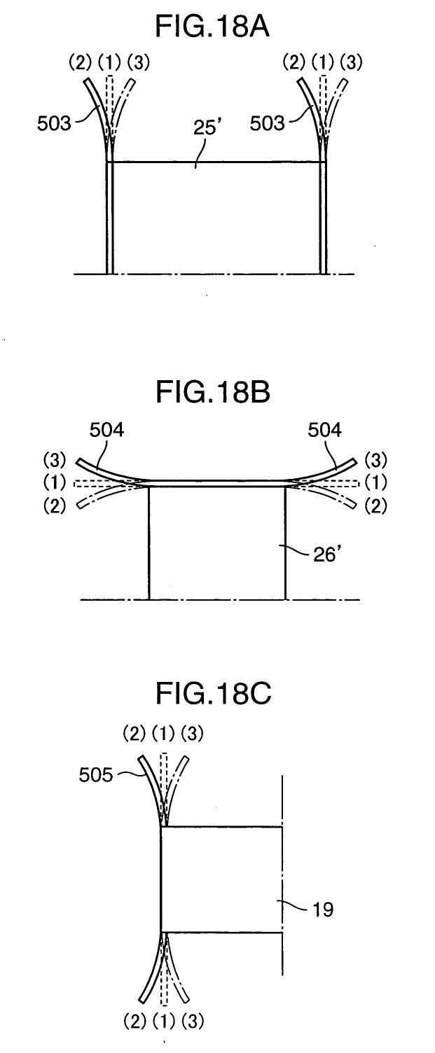

FIGS. 18A and 18B are views showing the first and second frames 501, 502 of the image pickup unit driving mechanism 500 when viewed in Z-axis direction from the photographic optical system 51, and FIG. 18C is a view of the image pickup unit 19 when viewed in X-axis direction. It should be noted that the piezoelectric elements 506 are not shown in FIGS. 18A to 18C for better visibility.

In the respective figures, state (1) is such that no currents are supplied to the piezoelectric elements 506 and the first, second and third elastic plates 503, 504, 505 are not influenced by the warping deformations of the piezoelectric elements 506, whereas states (2), (3) are such that currents are supplied to the piezoelectric elements 506 and the first, second and third elastic plates 503, 504, 505 are influenced by the warping deformations of the piezoelectric elements 506. It should be noted that the states (2), (3) differ in that warped directions are opposite because the current supplying directions to the piezoelectric elements 506 are opposite.

Taking advantage of the warping deformations by the piezoelectric elements 506, the first frame 501 is moved in a direction of arrow A1 shown in FIG. 17A by causing the first elastic plates 503 to instantaneously repeat the state (1) and the state (2), and the first frame 501 is moved in a direction of arrow A2 shown in FIG. 17A by causing the first elastic plates 503 to repeat the states (1) and (3) for example, as shown in FIG. 18A.

Similarly, the second frame 502 is moved in a direction of arrow B1 shown in FIG. 17A by causing the second elastic plates 504 to repeat the state (1) and the state (2), and the second frame 502 is moved in a direction of arrow B2 shown in FIG. 17A by causing the second elastic plates 504 to repeat the states (1) and (3), for example, as shown in FIG. 18B. Further, the image pickup unit 19 is moved in a direction of arrow C1 shown in FIG. 17A by causing the third elastic plates 505 to repeat the state (1) and the state (2), and the image pickup unit 19 is moved in a direction of arrow C2 shown in FIG. 17A by causing the third elastic plates 505 to repeat the states (1) and (3), for example, as shown in FIG. 18C.

The image pickup unit 19 can be driven along three axial directions also by the image pickup unit driving mechanism 500 constructed as above.

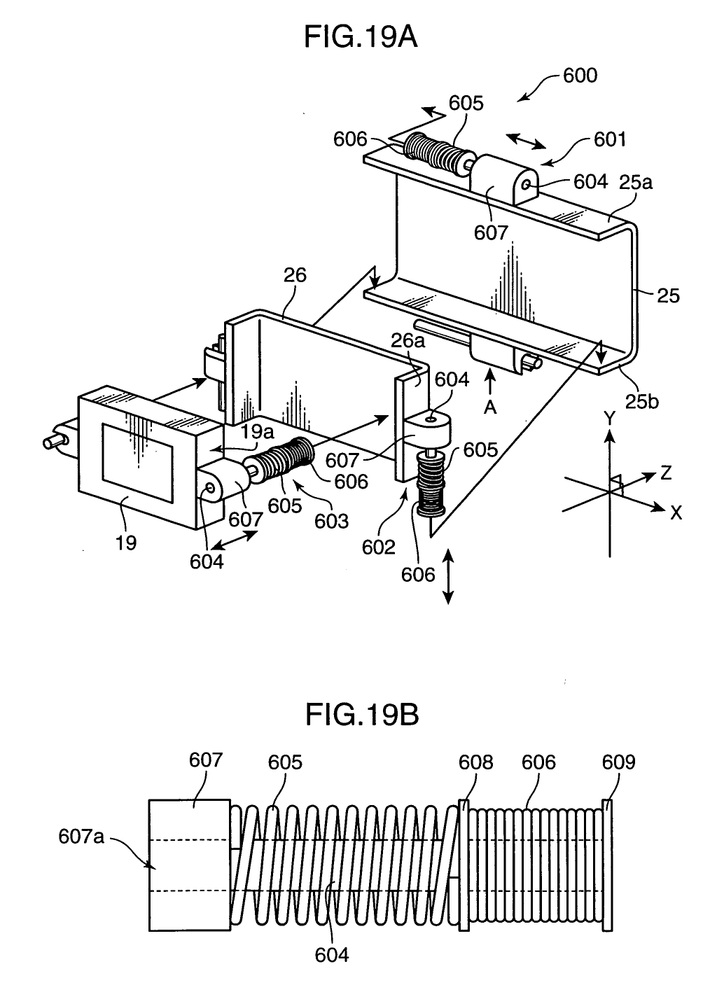

An image pickup unit driving mechanism 600 shown in FIGS. 19A and 19B is one example of a mode for imparting vibrations along three axial directions to the image pickup unit 19 using magnetic forces. An X-axis actuator 601, a Y-axis actuator 602 and a Z-axis actuator 603 have substantially similar constructions, and are respectively mounted on the first frame 25, the second frame 26 and the image pickup unit 19 substantially at the same positions as the X-axis actuator 27, the Z-axis actuator 29 and the Z-axis actuator 31 of the first embodiment (the X-axis actuator 601 is mounted on the outer surface of the first bent portion 25a of the first frame 25; the Y-axis actuator 602 on the outer surface of the first bent portion 26a of the second frame 26; and the Z-axis actuator 603 on the one end surface 19a of the image pickup unit 19).

As shown in FIG. 19B, each of the actuators 601 to 603 includes an iron core 604, a coil spring 605 and an electromagnetic coil 606. The iron core 604 has one end thereof inserted through a supporting body 607 formed with a through hole 607a, thereby being fixed to the supporting body 607.

Supporting plates 608, 609 are for supporting the coil spring 605 and the electromagnetic coil 606 and arranged to face each other with a specified interval therebetween. The supporting plate 609 of the X-axis actuator 601 is mounted (fixed by adhesive) at a specified position of the apparatus main body 1A; the supporting plate 609 of the Y-axis actuator 602 at a specified position of the underside of the second bent portion 25b of the first frame 25; and the supporting plate 609 of the Z-axis actuator 603 at a specified position of the flat portion 26c of the second frame 26.

The iron core 604 penetrates through the supporting plate 608, and the coil spring 605 is mounted on the iron core 604 between the supporting body 607 and the supporting plate 608, and the electromagnetic coil is wound around the iron core 604 between the supporting plates 608 and 609.

By causing a current to flow in a specified direction to the electromagnetic coil 606 in such a construction, an electromagnetic force (suction force) is produced between the iron core 604 and the electromagnetic coil 606, whereby the first or second frame 25, 26 or the image pickup unit 19 coupled to the supporting body 607 can be moved. Thus, vibrations can be imparted to the first and second frame 25, 26 and the image pickup unit 19 by suitably setting the frequencies of the currents caused to flow to the electromagnetic coils 606.

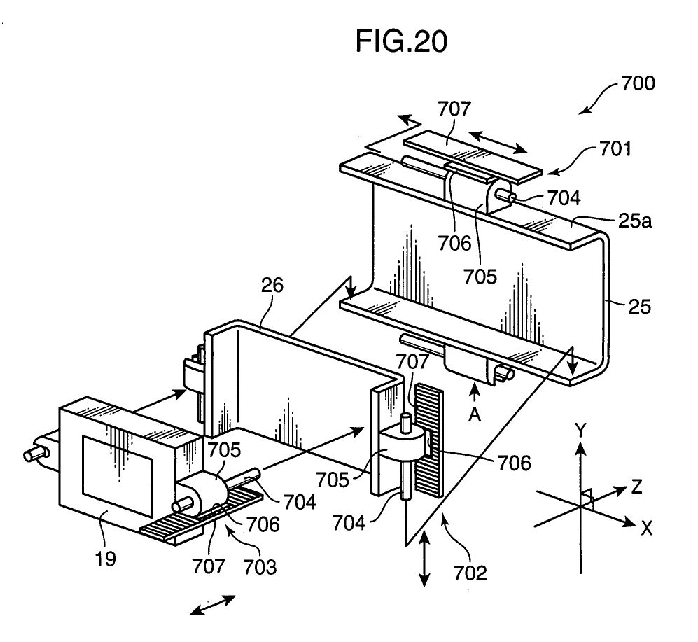

An image pickup unit driving mechanism 700 shown in FIG. 20 is one example of the mode for imparting vibrations along three axial directions to the image pickup unit 19 using electrostatic forces. An X-axis actuator 701, a Y-axis actuator 702 and a Z-axis actuator 703 have substantially similar constructions, and are respectively mounted on the first frame 25, the second frame 26 and the image pickup unit 19 substantially at the same positions as the X-axis actuator 27, the Z-axis actuator 29 and the Z-axis actuator 31 of the first embodiment.

Each of the actuators 701 to 703 includes a guide bar 704, a supporting body 705, a movable electrode 706 and a strip electrode 707. The guide bars 704 penetrate through the corresponding supporting bodies 705, and ends thereof at one side are mounted (fixed by adhesive) at suitable positions of the apparatus main body 1A, the first frame 25 and the second frame 26.

The strip electrodes 707 are mounted at suitable positions of the apparatus main body 1A, the first frame 25 and the second frame 26, and the movable electrodes 706 are so mounted on the corresponding supporting bodies 705 as to face the strip electrodes 707. Each strip electrode 707 has an elongated shape and a plurality of electrodes are juxtaposed along its longitudinal direction.

A suction force is produced between the movable electrode 706 and the strip electrode 707 by successively switching electrodes to which the specified current flows out of the plurality of electrodes, and the movable electrode 706 and, hence, the first frame 25, the second frame 26 or the image pickup unit 19 can be moved in a specified direction by this suction force. Therefore, vibrations can be imparted to the first frame 25, the second frame 26 and the image pickup unit 19 by suitably selecting the electrodes to which the specified currents flow and suitably setting the frequencies of the currents to the electrodes.

(6) Although the dust detecting operation and the dust removing operation are performed immediately after the photographing apparatus 1 is powered in the foregoing embodiment, the present invention is not limited thereto. For example, the set buttons 6 may include a dust removal button 6a (see FIG. 2) used to enter an instruction to start the execution of the dust removing operation, so that the execution of the dust removing operation can be instructed. Alternatively, the dust removing operation may be automatically performed immediately after the interchangeable lens is mounted or every time a specified number of photographing operations are performed. This enables a clear photographed image having no or little influence of dust to be stably generated, and makes it unnecessary for a photographer to instruct the starts of the dust detecting operation and the dust removing operation, thereby saving labor, if the photographing apparatus 1 is constructed to automatically start these operations. Therefore, the above can contribute to an improvement in the operability of the photographing apparatus 1.

If these operations are automatically started in the photographing apparatus 1, the photographing apparatus 1 may be constructed such that the dust detecting operation and the dust removing operation can be alternatively instructed.

(7) Although the dust removing operation is performed after dust is detected by the dust detecting operation in the first embodiment, the dust removing operation may be immediately performed without performing the dust detecting operation when an instruction is given from a user of the photographing apparatus 1 and, thereafter, the dust detecting operation may be performed.

(8) An object to which dust having entering the apparatus main body 1A attaches is not limited to the cover glass 22, and members exposed to the outside when the interchangeable lens 2 is detached from the apparatus main body 1A and all the members arranged on the light path between the photographic optical system 51 and the image pickup device 20 may be such objects. These objects include, for example, an infrared-cut filter using an interfering film for removing wavelength components outside the near-infrared region of an object light and dyes for absorbing the light, and a high-cut filter for removing frequency components of a specified level or higher from the object light, employing the birefringence phenomenon.

(9) In the constructions in FIGS. 5, 17 and other figures, the construction for imparting vibration along a direction normal to the image pickup surface of the image pickup unit 19 (e.g. Z-axis direction shown in FIG. 4) may be used for focusing. Then, this construction can double as the driving mechanism for focusing and the mechanism for imparting vibration along the direction normal to the image pickup unit 19, wherefore a cost increase and the enlargement of the apparatus can be prevented or suppressed.

As described above, a photographing apparatus comprises: an image pickup unit for receiving an image of light coming through a photographic optical system having an optical axis; a driving mechanism for moving the image pickup unit in a plurality of different directions over a plane intersecting the optical axis substantially perpendicularly; a shake corrector for controlling the driving mechanism to correct a shake of the light image due to an externally given shake; and a vibration imparter for controlling the driving mechanism to impart vibrations to the image pickup unit to thereby remove dust from the image pickup unit.

The vibration imparter imparts vibration to the image pickup unit to move the image pickup unit in the plane substantially perpendicular to the optical axis of the photographic optical system using the image pickup unit driving mechanism in this photographing apparatus. Accordingly, the dust attached to the image pickup unit can be more securely removed. Also, the cost increase and the enlargement of the apparatus can be prevented or suppressed as compared to the case where the vibration imparter and the shake corrector are separately installed. Further, a clear photographed image having no or little influence of the dust can be obtained.

The driving mechanism may be preferably provided with an actuator having an electromechanical conversion element which expands and contracts upon the application of a drive signal.

With this construction, the actuator provided for the shake correction is used to impart the vibration to the image pickup unit. Thus, as compared to the case where an actuator for imparting the vibration is provided in addition to the actuator for the camera shake correction, the cost increase and the enlargement can be suppressed at least by as much as the cost and size of the actuator.

The driving mechanism may be preferably provided with a moving member which is given a specified movement by an expanding/contracting motion of the electromechanical conversion element to thereby impart a vibration to the image pickup unit.

With this construction, the moving member is given with a specified movement by the expanding or contracting motion of the electromechanical conversion element and the vibration is transmitted to the image pickup unit utilizing this movement of the moving member. Accordingly, the vibration can be imparted to the image pickup unit by a relatively simple construction.

The image pickup unit may be mounted on a main body of the photographing apparatus. Preferably, a lens unit including the photographic optical system may be detachably mounted on the apparatus main body.

With this construction, a dust removing operation can be performed in a photographing apparatus having a high possibility of the entrance of dust into an apparatus main body because of the lens unit constructed to be detachably mountable on the apparatus main body. Thus, even if dust enters the apparatus main body while the lens unit is mounted or detached, the photographing apparatus can produce a clear photographed image having no or less image deterioration caused by this dust.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. a photographing apparatus comprising:
an image pickup unit for receiving an image of light coming through a photographic optical system having an optical axis;
a driving mechanism for moving the image pickup unit in a plurality of different directions over a plane intersecting the optical axis substantially perpendicularly;
a shake corrector for controlling the driving mechanism to correct a shake of the light image due to an externally given shake; and
a vibration imparter for controlling the driving mechanism to impart vibrations to the image pickup unit to thereby remove dust from the image pickup unit.

2. A photographing apparatus according to claim 1, wherein the driving mechanism includes an actuator having an electromechanical conversion element which expands and contracts upon the application of a drive signal.

3. A photographing apparatus according to claim 2, wherein the driving mechanism includes a moving member which is given a specified movement by an expanding/contracting motion of the electromechanical conversion element to thereby impart a vibration to the image pickup unit.

4. A photographing apparatus according to claim 1, wherein the image pickup unit is mounted on a main body of the photographing apparatus, further comprising:
a lens unit including the photographic optical system, the lens unit being detachably mounted on the apparatus main body.
